(19) United States
(12) Patent Application Publication
(10) Pub. No.: US 2016/0037595 A1
(43) Pub. Date: Feb. 4, 2016

(54) ALTERNATING-CURRENT HIGH-VOLTAGE MULTI-SEGMENT PARTITIONED LIGHT SOURCE DRIVING DEVICE AND METHOD THEREOF

(71) Applicant: SHENZHEN PUYI LIGHTING TECHNOLOGY CO., LTD, Shenzhen (CN)

(72) Inventors: Boqin YAN, Shenzhen (CN); Jianxin SHANG, Shenzhen (CN)

(21) Appl. No.: 14/799,117

(22) Filed: Jul. 14, 2015

Related U.S. Application Data
(63) Continuation of application No. PCT/CN2014/070540, filed on Jan. 13, 2014.

(30) Foreign Application Priority Data
Jan. 14, 2013 (CN) 201310015131.2

(51) Int. Cl. H05B 33/08

(52) U.S. Cl. CPC H05B 33/083; H05B 33/0842

(57) ABSTRACT

The present invention discloses an alternating high-voltage multi-segment partitioned light source driving device and method thereof. The device includes a power source, a signal control module, n segment constant-current driving modules, n MOS transistors and n segments of LED lights, where n is a natural number greater than or equal to 2. The signal control module is provided with an input end and n output ends. The power source separately connects electrically to the input end of the signal control module and the n segments of LED lights. Each of the constant-current driving module segments is connected in series with one corresponding MOS transistor in a one-to-one manner. The first to the m-th segments of LED lights are serially connected and then electrically connected to the m-th MOS transistor, where m is a natural number less than or equal to n. invention

### CROSS-REFERENCE TO RELATED APPLICATION

The present application is a US National Phase of PCT Application No. PCT/CN2014/070540, filed on Jan. 13, 2014, which claims a priority of the Chinese patent application No. 201310015131.2 filed on Jan. 14, 2013, which is incorporated herein by reference in its entirety.

### TECHNICAL FIELD

The present invention relates to the field of lighting, and more particularly to an alternating high-voltage multi-segment partitioned light source driving device and method thereof.

### BACKGROUND

LED light source are widely used in the lighting industry, particularly in backlights of liquid crystal display devices, street lighting and household appliances. In a driving device in the related art, in an alternating input voltage and an alternating input current generated by a power source, a light source usually works at a constant current region. For example, only at a shadow region of FIG. 7, the light source can work normally. Within a period of time from when the power source starts supply power to when reaching the constant current region, the light source cannot work normally, and thus useless work is done in this period of time. Further, a relationship between voltages and time is a sine waveform, and a square wave region in the sine waveform is a turn-on zone, i.e., a useful work region of LED light source (which is also the above constant current region). In order to ensure that brightness output from the LED lights can meet users' needs, the light sources have large power, while a working current of the LED light is usually about 20 mA.

In order to ensure that the LED lights can work normally, there are two ways which are currently used. The first way is as shown in FIG. 8, which increases a duty ratio of LED light source; although this way can make a circuit have a longer open time and improve overall performance, this way has a large power consumption region with no useful work, and thus the light source has a small power. The second way is as shown in FIG. 9, which can reduce duty ratio; although this way can reduce a power consumption region with no useful work, the LED light source has a very short working time, and cannot achieve satisfies result.

From the above description, the existing light source driving device cannot meet demands of the market.

### SUMMARY

For the shortcomings existing in the above technologies, the present invention provides an alternating high-voltage multi-segment partitioned light source driving device and method, which have simple structures, large power and high efficiency and which can achieve the effect of maximizing the turn-on zone and minimizing the no-light-consumption zone.

In order to achieve the above object, the present invention provides an alternating high-voltage multi-segment partitioned light source driving device including a power source, a signal control module, n segment constant-current driving modules, n MOS transistors and n segments of LED lights, wherein n is a natural number greater than or equal to 2. The signal control module is provided with an input end and n output ends; the power source is electrically connected with the input end of the signal control module and the n segments of LED lights, respectively. Each of the constant-current driving module segments is connected in series with one corresponding MOS transistor in a one-to-one manner; a first to an m-th segments of LED lights are serially connected and electrically connected to an m-th MOS transistor, wherein m is a natural number less than or equal to n.

Further, the signal control module is provided with a voltage detection unit configured to detect a turn-on voltage.

Further, the power source is provided with a bridge rectifier configured to receive an alternating voltage and supply the alternating voltage to each segment of LED lights.

Further, in each segment, the LED lights are connected in series.

In order to achieve the above object, the present invention further provides an alternating high-voltage multi-segment partitioned light source driving method including following steps:

step A, dividing LED lights into n segments which are successively turned on to work, and determining a turn-on voltage for each segment of LED lights, where n is a natural number greater than or equal to 2;

step B, when a voltage rises to the turn-on voltage for an m-th segment of LED lights, after the signal control module detects the turn-on voltage, transmitting by the signal control module, a signal to an m-th segment constant-current driving module, turning on, by the m-th constant-current driving module, an m-th MOS transistor which is connected in series with the m-th constant-current driving module, turning off an (m−1)-th MOS transistor, where m is a natural number less than or equal to n;

step C, powering a first segment to an m-th segment of LED lights which are connected in series to work, through the m-th MOS transistor which is turned on.

Further, in the step B, a voltage detection unit of the signal control module detects a turn-on voltage for each segment of LED lights.

Further, before completing the step A, the method further comprises a step D of converting an alternating voltage of the power source by a bridge rectifier, and dividing the converted voltage for each segment of LED lights.

Further, the LED lights include a first segment of LED lights, a second segment of LED lights, a third segment of LED lights and a fourth segment of LED lights; working steps comprises:

at step A1, when the voltage rises to the turn-on voltage for the first segment of LED lights, after the signal control module detects the turn-on voltage, the signal control module transmits a signal to a first segment constant-current driving module, the first segment constant-current driving module turns on a first MOS tube which is connected in series with the first segment constant-current driving module, the first segment of LED lights are powered to work through the first MOS tube which is turned on;

at step B1, when the voltage rises to the turn-on voltage for the second segment of LED lights, after the signal control module detects the turn-on voltage, the signal control module transmits a signal to a second segment constant-current driving module, the second segment constant-current driving module turns on a second MOS tube which is connected in series with the second segment constant-current driving module, the first MOS transistor is turned off, the first segment of LED lights and the second segment of LED lights which are connected in series are powered to work through the second MOS transistor which is turned on;

at step C1, when the voltage rises to the turn-on voltage for the third segment of LED lights, after the signal control module detects the turn-on voltage, the signal control module transmits a signal to a third segment constant-current driving module, the third segment constant-current driving module turns on a third MOS transistor which is connected in series with the third segment constant-current driving module, the second MOS transistor is turned off, the first segment of LED lights, the second segment of LED lights and the third segment of LED lights which are connected in series are powered to work through the third MOS transistor which is turned on;

at step D1, when the voltage rises to the turn-on voltage for the fourth segment of LED lights, after the signal control module detects the turn-on voltage, the signal control module transmits a signal to a fourth segment constant-current driving module, the fourth segment constant-current driving module turns on a fourth MOS transistor which is connected in series with the fourth segment constant-current driving module, the third MOS transistor is turned off, the first segment of LED lights, the second segment of LED lights, the third segment of LED lights and the fourth segment of LED lights which are connected in series are powered to work through the fourth MOS transistor which is turned on.

The present invention has following advantages. Comparing with the related art, in the alternating high-voltage multi-segment partitioned light source driving device and method provided in the present invention, the LED light source is divided into multiple segments, when a voltage rises to the turn-on voltage for one segment of LED lights, the signal control module outputs a signal to a segment constant-current driving module for this segment of LED lights. The segment constant-current driving module for this segment of LED lights turns on one MOS transistor which is connected in series with the segment constant-current driving module for this segment of LED lights. Meanwhile, former MOS transistor stops working; the constant-current driving module for this segment of LED lights supplies power to the first segment to this segment of LED lights through the MOS transistor, and then the first segment to this segment of LED lights are turned on to work. During the same period of working time, the power efficiency of the LED light source is effectively increased. In the present invention, the LED light source is divided into multiple segments according to the power of the turn-on zone and distribution requirements of the LED light source, working process is automated without human control, such that more segments provide more light, thereby maximizing the turn-on zone, minimizing the no-light-consumption zone, enhancing the efficiency of the power source, extending the service of the LED lights and improving the electricity provision efficiency of power plants.

### BRIEF DESCRIPTION OF THE DRAWINGS

FIG. 1 is a schematic view of an alternating high-voltage multi-segment partitioned light source driving device and method thereof according to the present invention;

FIG. 2 is a schematic view of the device when n is equal to 4 according to the present invention;

FIG. 3 is a diagram showing relationship between turn-on voltages and time when n is equal to 4 according to the present invention;

FIG. 4 is a diagram showing a working principle when n is equal to 4 and when rising from 0 degrees to 90 degrees;

FIG. 5 is a partial schematic view of the device when n is equal to 4 according to the present invention;

FIG. 6 is a diagram showing four segments of LED lights when n is equal to 4 according to the present invention;

FIG. 7 is a diagram showing relationship between voltages and currents;

FIG. 8 is a diagram showing a first relationship between voltages and currents in the related art;

FIG. 9 is a diagram showing a second relationship between voltages and currents in the related art.

Element labels are described as follows:
10 power source
11 signal control module
12 first segment constant-current driving module
13 second segment constant-current driving module
14 third segment constant-current driving module
15 fourth segment constant-current driving module
16 first segment of LED lights
17 second segment of LED lights
18 third segment of LED lights
19 fourth segment of LED lights
20 first MOS transistor
21 second MOS transistor
22 third MOS transistor
23 fourth MOS transistor

### DETAILED DESCRIPTION

In order to illustrate the present invention more clear, the present invention will be further described in conjunction with the accompanying drawings.

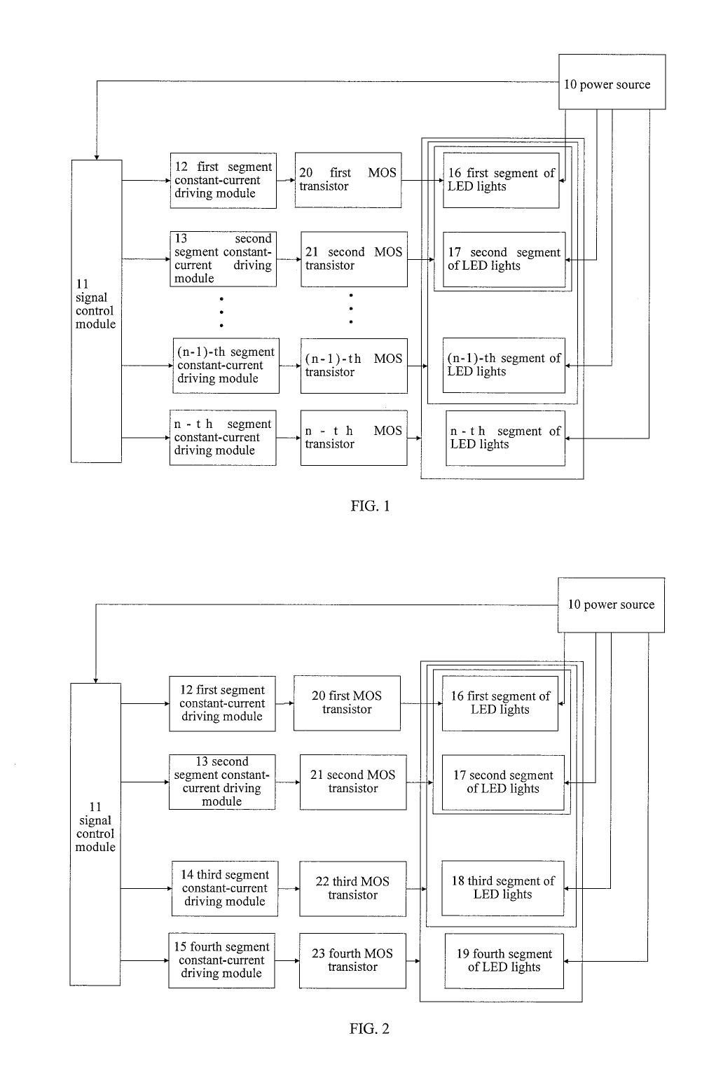

Referring to FIG. 1, an alternating high-voltage multi-segment partitioned light source driving device according to the present invention includes a power source 10, a signal control module 11, n segment constant-current driving modules, n MOS transistors and n segments of LED lights, where n is a natural number greater than or equal to 2. The signal control module 11 is provided with an input end and n output ends. The power source 10 is electrically connected with the input end of the signal control module 11 and the n segments of LED lights, respectively. Each of the constant-current driving module segments is connected in series with one corresponding MOS transistor in a one-to-one manner. A first to an m-th segments of LED lights are serially connected and then electrically connected to an m-th MOS transistor, where m is a natural number less than or equal to n. A logic working relationship of the n MOS transistors are as follows: 1) first being triggered first being turned on; 2) last being triggered last being turned on, after former MOS transistors are automatically turned off; 3) only allowing one segment to be turned on.

On-state characteristics of each segment of LED lights require the power source 10 to provide a constant current under condition of a stable voltage. Thus, here, a turn-on waveform is a square wave, that is to make each segment have the same turn-on voltage and the same number of LED lights, and make currents for various segments be square waves superimposed layer by layer, a bottom layer have a maximum turn-on duty ratio and a top layer have a minimum turn-on duty ratio. Since the various segments have different turn-on period of time (duty ratio), thus, the LED lights in the various segments have different amounts of work.

In the present embodiment, the signal control module 11 is provided with a voltage detection unit (not shown) configured to detect turn-on voltages. The power source 10 is provided with a bridge rectifier (not shown) configured to receive an alternating voltage and supply the alternating voltage to each segment of LED lights. An alternating high-voltage of the power source 10 is processed by the bridge rectifier (not shown) and then is supplied to each segment of LED lights.

In the present embodiment, in each segment, the LED lights are connected in series.

An alternating high-voltage multi-segment partitioned light source driving device according to the present invention includes following steps.

First step, dividing LED lights into n segments which are successively turned on to work, and determining a turn-on voltage for each segment of LED lights, where n is a natural number greater than or equal to 2.

Second step, when a voltage rises to the turn-on voltage for an m-th segment of LED lights, after the signal control module 11 detects the turn-on voltage, transmitting by the signal control module 11, a signal to an m-th segment constant-current driving module, turning on, by the m-th constant-current driving module, an m-th MOS transistor which is connected in series with the m-th constant-current driving module, turning off an (m−1)-th MOS transistor, where m is a natural number less than or equal to n.

Third step, powering a first segment to an m-th segment of LED lights which are connected in series to work, through the m-th MOS transistor which is turned on.

In the present invention, in the first step, the voltage detection unit (not shown) of the signal control module 11 detects a turn-on voltage for each segment of LED lights, respectively.

In the present invention, before completing the first step, the method further includes a step of converting an alternating voltage of the power source 10 by the bridge rectifier, and dividing the converted voltage for each segment of LED lights.

In order to better illustrate the present invention, a specific embodiment in which n is equal to 4 is given below for illustration.

Further referring to FIGS. 2-6, the LED lights include a first segment of LED lights 16, a second segment of LED lights 17, a third segment of LED lights 18 and a fourth segment of LED lights. Working steps are as follow.

First step, when a voltage rises to a turn-on voltage for the first segment of LED lights 16, after the signal control module 11 detects the turn-on voltage, the signal control module 11 transmits a signal to a first segment constant-current driving module 12, the first segment constant-current driving module 12 turns on a first MOS transistor 20 which is connected in series with the first segment constant-current driving module 12, the first segment of LED lights 16 are powered to work through the first MOS transistor which is turned on.

Second step, when the voltage rises to a turn-on voltage for the second segment of LED lights 17, after the signal control module 11 detects the turn-on voltage, the signal control module 11 transmits a signal to a second segment constant-current driving module 13, the second segment constant-current driving module 13 turns on a second MOS transistor 21 which is connected in series with the second segment constant-current driving module 13, the first MOS transistor 20 is turned off, the first segment of LED lights 16 and the second segment of LED lights 17 which are connected in series are powered to work through the second MOS transistor 21 which is turned on.

Third step, when the voltage rises to a turn-on voltage for the third segment of LED lights 18, after the signal control module 11 detects the turn-on voltage, the signal control module 11 transmits a signal to a third segment constant-current driving module 14, the third segment constant-current driving module 14 turns on a third MOS transistor 22 which is connected in series with the third segment constant-current driving module 14, the second MOS transistor 21 is turned off, the first segment of LED lights 16, the second segment of LED lights 17 and the third segment of LED lights 18 which are connected in series are powered to work through the third MOS transistor 22 which is turned on.

Fourth step, when the voltage rises to a turn-on voltage for the fourth segment of LED lights 19, after the signal control module 11 detects the turn-on voltage, the signal control module 11 transmits a signal to a fourth segment constant-current driving module 15, the fourth segment constant-current driving module 15 turns on a fourth MOS transistor 23 which is connected in series with the fourth segment constant-current driving module 15, the third MOS transistor 22 is turned off, the first segment of LED lights 16, the second segment of LED lights 17, the third segment of LED lights 18 and the fourth segment of LED lights 19 which are connected in series are powered to work through the fourth MOS transistor 23 which is turned on.

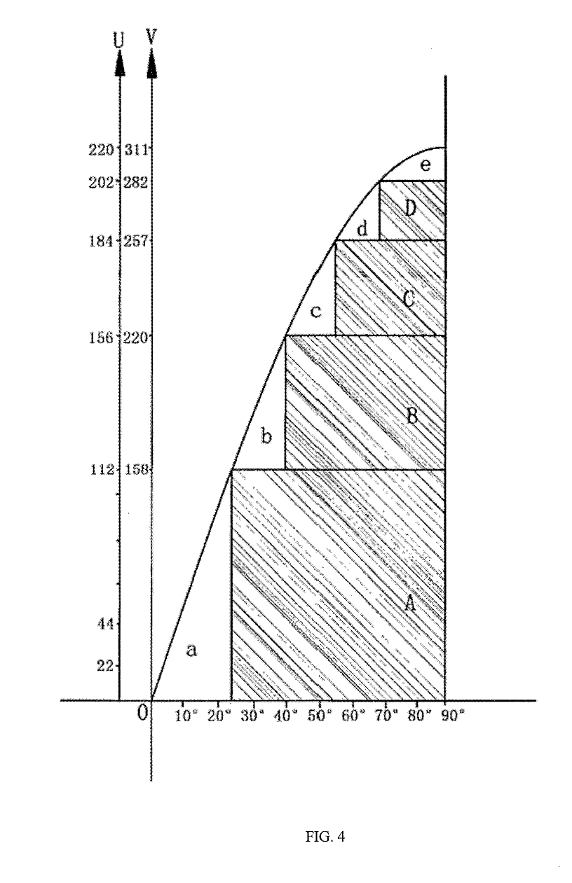

The work of the four segments of LED lights is analyzed as follows. When the voltage rises to Vf1, a signal is output from an output end of the signal control module 11 to the first segment constant-current driving module 12. The first segment constant-current driving module 12 starts to work and turns on the first MOS transistor 20 which is connected in series with the first segment constant-current driving module 12, and then the first segment of LED lights 16 are turned on. Similarly, when the voltage rises to Vf2, Vf3 or Vf4, the signal control module 11 automatically detects the turn-on voltage, and the first, second, third and fourth MOS transistors are successively turned on in such a manner that the former MOS transistor is automatically turned off when the latter MOS transistor is turned on. Finally, the first segment of LED lights 16, the second segment of LED lights 17, the third segment of LED lights 18 and the fourth segment of LED lights 19 are powered through the fourth MOS transistor 23. In the four segments and four regions, the first segment of LED lights 16 and the second segment of LED lights 17 are a main region, the third segment of LED lights 18 is a secondary region, and the fourth segment of LED lights 19 is an auxiliary region; thus, the first segment of LED lights 16 and the second segment of LED lights 17 as the main region give a largest contribution to luminescence, the fourth segment of LED lights 19 as an auxiliary region gives a minimum contribution to luminescence so as to reduce no-light-power-consumption. Further referring to FIG. 4, in FIG. 4, U represents an effective value of voltage, and V represents a stand working value of voltage; then, values of useful wok and useless work of each segment of a changed waveform are analyzed so as to determine a reasonable allocation of the four segments.

1) From O to A in a voltage waveform, an A region is turned on, there is no power consumption in the a region, a maximum duty ratio of a conduction angle is largest in luminescence, a high incidence ratio is the highest, and the work is also the biggest.

2) From A to B in the voltage waveform, in order to maintain a constant current in the A region before LEDs are turned on in the B region, the first segment constant-current driving module 12 has to bear a voltage drop from the A region to the B region, a current value is 20 MA, there is power consumption in the b region, there is no light and no power consumption in the a region; similarly, c and d regions ineffective power consumption regions of constant-current driving modules. Thus, a principle of reasonable partition is to maximize the bottom region since the bottom region has the largest effective luminous power. Since the MOS transistor has a low turn-on voltage drop, thus the power consumption is minimal. There is a voltage but no current in the A region, thus there is no power consumption in the A region. There is no power consumption in the a region. In the four working regions including b, c, d and e regions shown in FIG. 4 which produces no light (i.e., useless work regions), the b region exists after the A region emits light and before the B region emits light; the c region exists after the B region emits light and before the c region emits light; the e region exists after the D region emits light and to a maximum value of a sine wave. These four regions are in a rotary state from b to c, from c to d, from d to e, and only rotate from one region to a top region. Only one of b, c, d, e regions exists at one time. Instead, luminous states of the four luminous regions including A, B, C and D are A->A+B->A+B+C->A+B+C+D, i.e., the first segment of LED lights 16 at the A region emit light, the first segment of LED lights 16 and the second segment of LED lights 17 at the B region emit light, the first segment of LED lights 16, the second segment of LED lights 17 and the third segment of LED lights 18 at the C region emit light, and the first segment of LED lights 16, the second segment of LED lights 17, the third segment of LED lights 18 and the fourth segment of LED lights 19 at the D region emit light.

The numbers of LEDs in the four regions are allocated and selected as: for A region: 51 LED lights each having a forward voltage drop (VF), VF=3.1V, 51*3.1V=158V, an effective value is 112V; for B region: 20 LED lights each having a VF, VF=3.1V, 20*3.1V=62V, an effective value is 44V; for C region: 12 LED lights each having a VF, VF=3.1V, 12*3.1V=37V, an effective value is 26V; for D region: 8 LED lights each having a VF, VF=3.1V, 8*3.1V=25V, an effective value is 18V.

When calculating powers of the four regions, an instant peak of voltage is converted into an effective value, and the current is effective. Therefore, for A region: 158V/1.4142*0.02 A=2.236V; for B region: 62V/1.4142*0.02 A=0.877 W; for C region: 37.2V/1.4142*0.02 A=0.526 W; for D region: 24.8V/1.4142*0.02 A=0.351 W. A total power of the four regions is 3.99 W, and is approximately equal to 4 W. A total input power is 220V*0.02 A=4.4 W. A power efficiency is 4 W/4.4 W*100%=90.9%. The above value 1.4142 is a reciprocal of a power factor.

It can be seen from the above calculation, in the method provided in the present invention, power efficiency of the LED light source=total power of the various regions/total input power; while the total input power is fixed, the total power of the various regions is a sum of effective powers of the various regions, an effective power of each region=voltage*current*power factor. In the present invention, if there are more segments, the power efficiency is higher. The driving device includes no capacitive components and no inductive components, as long as wiring is reasonable, less capacitor and inductors are distributed. Even if there is a voltage and no current in the a region, it will cause phase shift, and the power factor is 1.0, thereby improving the electricity provision efficiency of power plants.

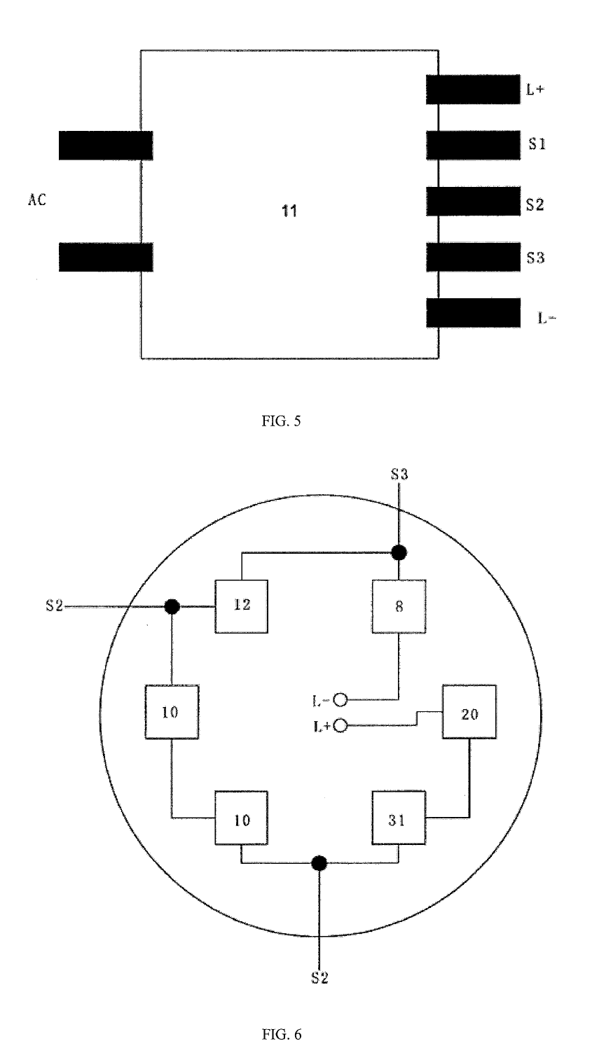

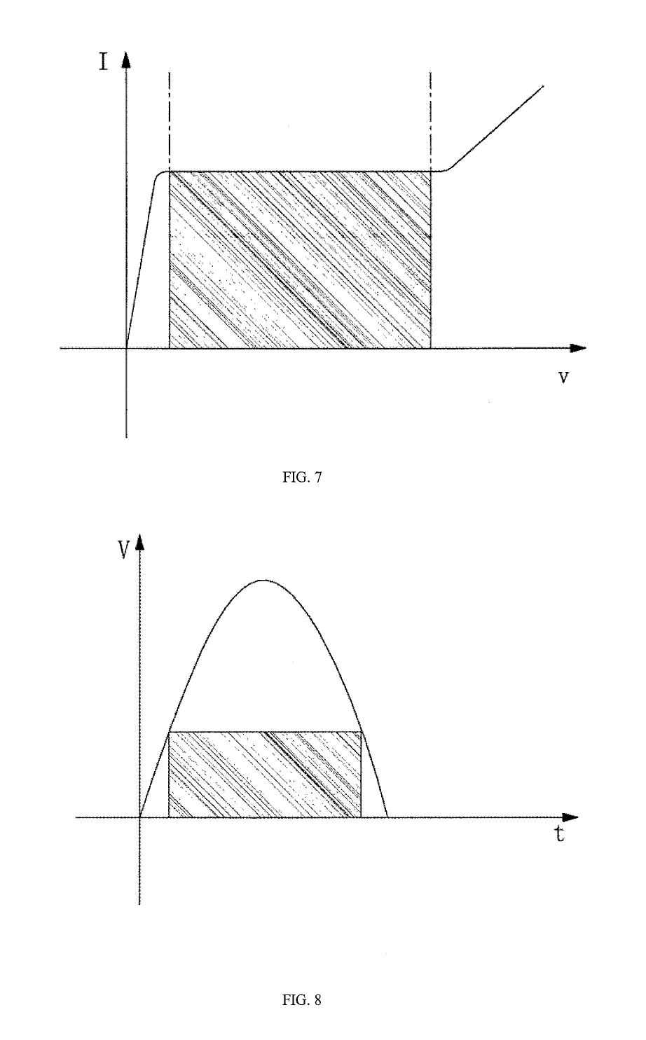

In the present invention, the number of LED lights in one former segment is greater than or equal to the number of LED lights in one latter segment. In each region, LED efficiencies and turn-on voltages for n segments are different, more LED lights are provided in regions providing more useful work. For example, in the above embodiment when n is equal to 4, the number of LED lights in each segment is shown in FIG. 6. The first segment of LED lights 16 includes 51 lights connected in series; the second segment of LED lights 17 includes 20 lights connected in series; the third segment of LED lights 18 includes 12 lights connected in series; the fourth segment of LED lights 19 includes 8 lights connected in series. The LED light is directly encapsulated on a circuit board with a diameter of 5 cm. The present invention is not limited to the numbers of LED lights in each segment; users can determine the numbers of LED lights in each segment according to the power of the turn-on zone and distribution of the light source. If changing the numbers of LED lights in each segment, as long as it can be ensured that the number of LED lights in one former segment is greater than or equal to the number of LED lights in one latter segment, then, this changing can be understood as a simple modification or substitution, and will fall in the scope of the present invention.

The present invention has following advantages. The LED light source is divided into multiple segments. When a voltage rises to the turn-on voltage for one segment of LED lights, the signal control module 11 outputs a signal to a segment constant-current driving module for this segment of LED lights. The segment constant-current driving module for this segment of LED lights turns on one MOS transistor which is connected in series with the segment constant-current driving module for this segment of LED lights. Meanwhile, former MOS transistor stops working; the constant-current driving module for this segment of LED lights supplies power to the first segment to this segment of LED lights through the MOS transistor, and then the first segment to this segment of LED lights are turned on to work. During the same period of working time, the power efficiency of the LED light source is effectively increased. In the present invention, the LED light source is divided into multiple segments according to the power of the turn-on zone and distribution requirements of the LED light source, working process is automated without human control, such that more segments provide more light, thereby maximizing the turn-on zone, minimizing the no-light-consumption zone, enhancing the efficiency of the power source and extending the service of the LED lights.

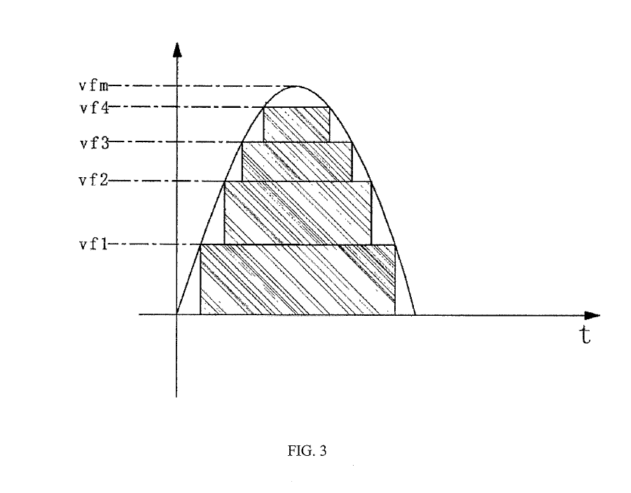

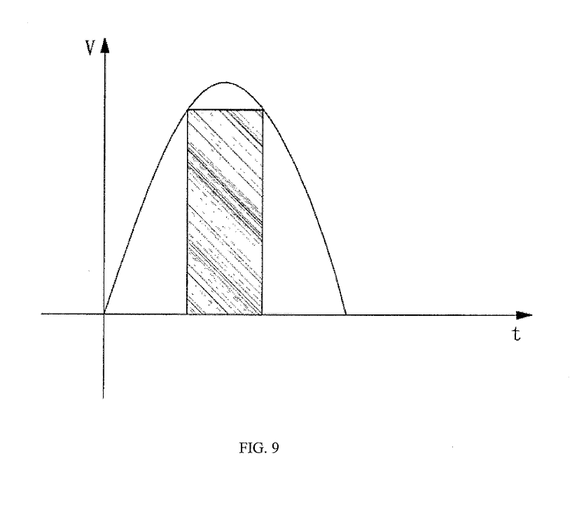

In FIGS. 3 and 8-9, a shadow region represents a turn-on zone, a blank region in the sine waveform represents a power consumption region with no useful work. Comparing these three figures, it can be see that a sum of the turn-on zones in FIG. 3 is the largest, and a sum of power consumption regions with no useful work is the smallest. Thus, in the three ways, FIG. 3 is most suitable. It can be obtained through the above calculation that the LED light source has more segments, the efficiency of the power source is higher, thereby improving use efficiency of the power source.

Those described above are several embodiments of the present invention, and are not used to limit the present invention. For those skilled in the art, improvements and substitutions may also be made without departing from the principle of the present invention. Those improvements and substitutions should also be considered as the scope of the present invention.

What is claimed is:

1. An alternating high-voltage multi-segment partitioned light source driving device comprising a power source, a signal control module, n segment constant-current driving modules, n MOS transistors and n segments of LED lights, wherein n is a natural number greater than or equal to 2;
wherein the signal control module is provided with an input end and n output ends; the power source is electrically connected with the input end of the signal control module and the n segments of LED lights, respectively;
wherein each of the constant-current driving module segments is connected in series with one corresponding MOS transistor in a one-to-one manner; a first to an m-th segments of LED lights are serially connected and electrically connected to an m-th MOS transistor, wherein m is a natural number less than or equal to n.

2. The alternating high-voltage multi-segment partitioned light source driving device according to claim 1, wherein the signal control module is provided with a voltage detection unit configured to detect a turn-on voltage.

3. The alternating high-voltage multi-segment partitioned light source driving device according to claim 1, wherein the power source is provided with a bridge rectifier configured to receive an alternating voltage and supply the alternating voltage to each segment of LED lights.

4. The alternating high-voltage multi-segment partitioned light source driving device according to claim 1, wherein in each segment, the LED lights are connected in series.

5. An alternating high-voltage multi-segment partitioned light source driving method comprising following steps:
step A, dividing LED lights into n segments which are successively turned on to work, and determining a turn-on voltage for each segment of LED lights, where n is a natural number greater than or equal to 2;
step B, when a voltage rises to the turn-on voltage for an m-th segment of LED lights, after the signal control module detects the turn-on voltage, transmitting by the signal control module, a signal to an m-th segment constant-current driving module, turning on, by the m-th constant-current driving module, an m-th MOS transistor which is connected in series with the m-th constant-current driving module, turning off an (m−1)-th MOS transistor, where m is a natural number less than or equal to n;
step C, powering a first segment to an m-th segment of LED lights which are connected in series to work, through the m-th MOS transistor which is turned on.

6. The alternating high-voltage multi-segment partitioned light source driving method according to claim 5, wherein in the step B, a voltage detection unit of the signal control module detects a turn-on voltage for each segment of LED lights.

7. The alternating high-voltage multi-segment partitioned light source driving method according to claim 5, wherein before completing the step A, the method further comprises a step D of converting an alternating voltage of the power source by a bridge rectifier, and dividing the converted voltage for each segment of LED lights.

8. The alternating high-voltage multi-segment partitioned light source driving method according to claim 5, wherein the LED lights comprise a first segment of LED lights, a second segment of LED lights, a third segment of LED lights and a fourth segment of LED lights; working steps comprises:
at step A1, when the voltage rises to the turn-on voltage for the first segment of LED lights, after the signal control module detects the turn-on voltage, the signal control module transmits a signal to a first segment constant-current driving module, the first segment constant-current driving module turns on a first MOS transistor which is connected in series with the first segment constant-current driving module, the first segment of LED lights are powered to work through the first MOS transistor which is turned on;
at step B1, when the voltage rises to the turn-on voltage for the second segment of LED lights, after the signal control module detects the turn-on voltage, the signal control module transmits a signal to a second segment constant-current driving module, the second segment constant-current driving module turns on a second MOS transistor which is connected in series with the second segment constant-current driving module, the first MOS transistor is turned off, the first segment of LED lights and the second segment of LED lights which are connected in series are powered to work through the second MOS transistor which is turned on;
at step C1, when the voltage rises to the turn-on voltage for the third segment of LED lights, after the signal control module detects the turn-on voltage, the signal control module transmits a signal to a third segment constant-current driving module, the third segment constant-current driving module turns on a third MOS transistor which is connected in series with the third segment constant-current driving module, the second MOS transistor is turned off, the first segment of LED lights, the second segment of LED lights and the third segment of LED lights which are connected in series are powered to work through the third MOS transistor which is turned on;
at step D1, when the voltage rises to the turn-on voltage for the fourth segment of LED lights, after the signal control module detects the turn-on voltage, the signal control module transmits a signal to a fourth segment constant-current driving module, the fourth segment constant-current driving module turns on a fourth MOS transistor which is connected in series with the fourth segment constant-current driving module, the third MOS transistor is turned off, the first segment of LED lights, the second segment of LED lights, the third segment of LED lights and the fourth segment of LED lights which are connected in series are powered to work through the fourth MOS transistor which is turned on.

9. The alternating high-voltage multi-segment partitioned light source driving device according to claim 3, wherein in each segment, the LED lights are connected in series.
